(19) United States
(12) Patent Application Publication
(10) Pub. No.: US 2010/0303561 A1
(43) Pub. Date: Dec. 2, 2010

(54) TOOL HOLDER AND CUTTING INSERT WITH CENTERING NOSE PORTION

(75) Inventor: Richard Fouquer, Saint Cyr Sur Loire (FR)

Correspondence Address: ADELI & TOLLEN, LLP, 11940 San Vicente Blvd., Suite 100, LOS ANGELES, CA, 90049, US

(73) Assignee: Safety Production, Boulogne Billancourt (FR)

(21) Appl. No.: 12/600,258

(22) PCT Filed: May 16, 2008
(86) PCT No.: PCT/FR2008/000682

§ 371 Date: Nov. 14, 2009

(30) Foreign Application Priority Data
May 16, 2007 (FR) 0703530

(51) Int. Cl. B23P 15/28; B26D 3/00

(52) U.S. Cl. 407/102; 407/113

(57) ABSTRACT

The cutting tip comprises a lateral face for aligned lateral positioning against a lateral alignment line with a tool holder housing, comprising an alignment snout with first and second lateral alignment surfaces that bear respectively against first and second lateral driving alignment surfaces and comprising, at some distance, a third lateral alignment surface for bearing against a third lateral driving alignment wall surface, two out of the first, second and third alignment surfaces being mutually inclined in such a way as to ensure alignment in a chosen position of travel with respect to the driving lateral wall surfaces opposite.

### FIELD OF THE INVENTION

The present invention relates to cutting inserts, and in particular their mounting on carrier tool.

### BACKGROUND OF THE INVENTION

If we consider for example the case of a drill, the associated cutting insert is received inside a pocket in the form of a slot forwardly open in diametrical position. The cutting insert usually has an overall spearpoint shape, that is a diamond shape with two forwardly directed male V-shaped lateral faces, centered on the geometrical axis of rotation of the drill, and two lateral male V-shaped faces similarly centered and backwardly directed.

The two forward lateral faces each define, together with one respective major face of the cutting insert, two V-shaped male cutting edges, considered in plan view, and the two rear positioning lateral faces are used for registering by back abutment against two similarly V-shaped female registering walls of the pocket.

The insert is firmly held in the desired registered position, i.e. axially retracted, by tightening two clamping jaws defining the pocket and which clamp the two opposing major faces of the cutting insert as a result of their elasticity or by means of a through screw.

Accuracy of registration of the cutting insert is of considerable importance considering that any undesirable offset would lead to the active tip of the insert getting off-center so that the increase of radial coverage of one of the two cutting edges thus caused would result in increasing the diameter of drilling.

Such radial offset can have two possible causes. The first cause is related to some fault in clamping the insert, and it is relatively easy to design effective clamping mechanisms. The second cause is related to accuracy of geometry of the registering surfaces in contact, i.e. the degree of flatness of the two female V-shaped lateral walls of the pocket and of the two lateral positioning faces of the insert. It is also essential for the two registering V-shapes, male and female, to be at exactly the same angle. Further, any unwanted debris stuck to either one of the V-shaped surfaces will be detrimental to registration. Highly accurate machining of the tool body and of the inserts in such a drill is consequently required, representing non-negligible cost. Further, registration is not always perfect, as a result of debris.

### SUMMARY OF THE INVENTION

The present invention sets out to provide a solution making it possible to limit the above cost, and diminish the risk of imperfect registration.

To this end, the invention first provides a cutting insert comprising a lateral registered positioning face of registration against a lateral registering wall of a pocket in a tool holder, characterized by the fact that the lateral positioning face comprises, firstly, a first registering portion comprising a guided registering relief for constraining two degrees of freedom of motion of the cutting insert on a base of said pocket, the registering relief comprising first and second guided registering lateral surfaces provided for registration abutment against respective first and second guiding registering lateral surfaces of said tool holder pocket and, secondly, at a determined distance from the first registering portion, a second registering portion comprising a third guided registering lateral surface for constraining a further degree of freedom of motion of said insert on said base of the pocket, through abutment against a third guiding registering lateral wall surface of said pocket, two out of the first, second and third registering surfaces being mutually inclined so as to ensure registration in a determined traveling position, with respect to the guiding registering lateral surfaces opposite thereto.

The idea behind the invention is thus to avoid one or two lateral sides of the cutting insert being laterally supported over their whole length. Support is, in contrast, similar to that of a beam, i.e. at two remote portions, preferably located respectively at two opposing ends of the lateral face, to avoid any tendency to rotate about two points of support if these were close together, the effect of which would be to increase, at a remote portion of the lateral positioning face, uncertainty of positioning, likely to persist at the surfaces in abutment.

It will be noted that the third guided lateral surface can be situated, remote from the guided relief, along a direction of local extension of the first portion of the lateral positioning face, or it can equally as well be along a direction oblique thereto. In other words, the lateral positioning face can be substantially rectilinear or be elbowed, making it functionally equivalent to two registering lateral walls, for example at 90° to each other. The cutting insert of the invention can consequently be mounted in any housing or pocket of a drill bit or other tool holder, having one or two lateral registering walls.

To take an example, the first and second guided registering lateral surfaces are directed at least partially in opposite directions with respect to a local direction of extension of said lateral positioning face. They thus perform a “traveling” registration of the insert allowing the insert to move in front of the registering wall.

If in effect, to take a non-limiting example, we were to consider that the guided registering relief is a positive relief, in the form of a nose portion, the latter would be provided to engage with a registering cavity or recess in the pocket wall. It is now easy to ensure the recess has an appropriate shape and depth such that the first and second guided lateral surfaces come into abutment, in said opposite senses, at respectively the first and second guiding lateral surfaces of the recess, so as to thereby determine the “traveling” position for the lateral face positioning the cutting insert up against the lateral registering wall. This results in constraining a first degree of freedom in lateral translational motion, X, of the cutting insert at the nose portion. Further, the degree to which the nose portion penetrate into the recess is determined by the shape and size of the nose portion and of the guiding registering lateral walls of the recess, which can for example have a V-shape with centering effect, thereby constraining the second degree of freedom, Y.

The guiding registering lateral walls can also form respectively the two parallel sides of a U-shaped recess, at least one of the sides being turned back in the opposite direction, through any desired angle, thereby forming the base of the recess, against which the nose portion will abut. This thus constrains, at the nose portion, the second degree of freedom of motion, Y, of the cutting insert in the direction of the relevant registering lateral wall.

Thus, generally speaking, the guided relief is adapted to receive three components of registering reaction force from the guiding relief, consisting of two components in opposite senses, providing “X”, “traveling” in front of the registering lateral wall registration, and a component perpendicular thereto defining “Y” registration, in other words the degree to which the guiding and guided reliefs penetrate one into the other, thereby defining a clearance distance between the remainder of the positioning lateral face, not laterally in abutment, and a region of the relevant registering lateral wall opposite thereto. The guided relief can be one piece, in other words consist of a nose portion and/or recess bounded by the first and second registering surfaces, or can involve a physical structure the first and second registering surfaces of which each correspond to a respective local relief, with optionally some distance separating these two local reliefs, and which together constitute, from a functional point of view, the guided registering relief.

Turning now to the positioning of the third guided lateral surface, the guided relief can perform the function of a pin for initial centering, after which the cutting insert is slid down to the base of the pocket. The guided relief will preferably be adapted to allow that, once it is engaged with the guiding relief, the insert can perform a slight rotating movement about the guiding relief, i.e. the guiding relief will become the axis for a final rotation whereby the third guided lateral surface gets pushed against the third guiding lateral surface.

If, in contrast, one or the other of the guided relief and guiding relief were to be a U-shaped recess and the other a nose portion of the same width having at least one of its lateral surfaces plane, so as to be able to solely slide and penetrate into the groove without any possibility of rotate, the third lateral surface will now approach the third guiding lateral wall surface via a linear movement parallel to the direction of sliding insertion of the nose portion into the groove. In other words, in this case, both docking movements, that of the guided relief via the first and second guided lateral surfaces, and that of the third guided lateral surface will be simultaneous, describing identical linear movements.

Generally speaking, the various lateral points of support can be arranged for relatively local contact, thereby limiting the risk of creating excess thickness as a result of debris getting stuck.

In one embodiment, the first and second guiding registering lateral surfaces extend in generally mutually inclined directions of extension, in other words they generally form a V-shape. If the relevant lateral surfaces are of non-rectilinear shape, their general direction of extension can be defined as being parallel to a straight line joining two opposing extreme points of the surface considered, which for example would be a chord where the lateral surface has a circular profile.

Advantageously, their mean direction is perpendicular to the direction of extension of the lateral face whereby any manufacturing tolerance in the length of the V or in the angle between the two branches thereof will not bring about any error in “traveling” positioning. The same applies to any tolerance in a guiding V-shaped relief, i.e. in the pocket receiving the insert. This is particularly interesting when a drill cutting insert is supported by its rear lateral face, whereby the insert will remain centered. Such manufacturing tolerances will only bring about a slight axial offset, which represents no disadvantage.

The first and second guiding registering lateral surfaces can be curved surfaces, for example convex. The guiding relief can also be arranged to have concave first and second guiding wall surfaces, so that one of the reliefs, the female relief, forms a cradle the radius of curvature of the first and second surfaces/walls of which is slightly greater or even equal to the radius of curvature of the two corresponding surfaces of the male relief, in order to allow the slight rotation discussed above, for the docking movement of the third guided lateral surface.

Preferably, the third lateral surface is carried by a registering heel. This will ensure a certain lateral clearance is always present, avoiding any risk of undesirable contact between the lateral wall of the pocket and those parts of the lateral positioning face which are not intended to come into abutment.

The invention also provides a tool holder adapted to receive a cutting insert according to the invention, comprising an insert pocket having a lateral registering wall including, firstly, a first registering wall portion comprising a guiding registering relief for constraining two degrees of freedom of motion of the cutting insert on a base of the pocket, said guiding registering relief having first and second guiding registering surfaces adapted to receive respectively, in registration abutment therewith first and second guided registering lateral surfaces of the cutting insert and, secondly, at a determined distance from said first portion of the registering wall, a second guiding registering wall portion comprising a third guiding lateral surface for constraining a further degree of freedom of motion of the insert on the base of said pocket, by receiving in abutment therewith a third guided surface of lateral registering wall of the insert, two out of the first, second and third guiding registering surfaces being mutually inclined so as to provide, at the facing guided lateral wall surfaces of the insert, registration in a determined traveling position.

The first and second guiding registering lateral surfaces are for example generally directed at least partially in opposite senses with respect to a local direction of extension of the lateral registering wall.

In one embodiment, the first and second guiding registering lateral surfaces, which can be planar or curved, extend in generally mutually inclined directions.

The invention will be more readily understood from the description which follows of one embodiment and one alternative embodiment of a drill bit according to the invention fitted with a cutting insert according to the invention, with reference to the attached drawings.

### BRIEF DESCRIPTION OF THE DRAWINGS

FIG. 1 is a side view of the forward end of a drill bit fitted with a cutting insert seen in plan view, inserted against the base of a pocket provided in the drill bit, in a position close to a clamped operating position,

FIG. 2 is a front view of the drill bit fitted with the cutting insert of FIG. 1,

FIG. 3 is a side view of the drill bit and the cutting insert of FIG. 1,

FIG. 4 is an exploded view in perspective of one alternative embodiment of the drill bit and cutting insert of FIG. 1,

FIG. 5 is a rear view in perspective of the cutting insert of FIG. 4,

FIG. 6 is a plan view, similar to that of FIG. 1, of the cutting insert and drill bit of FIGS. 5 and 6, and

FIG. 7 is an end view of the drill bit, alone, of FIG. 4.

### DETAILED DESCRIPTION OF THE INVENTION

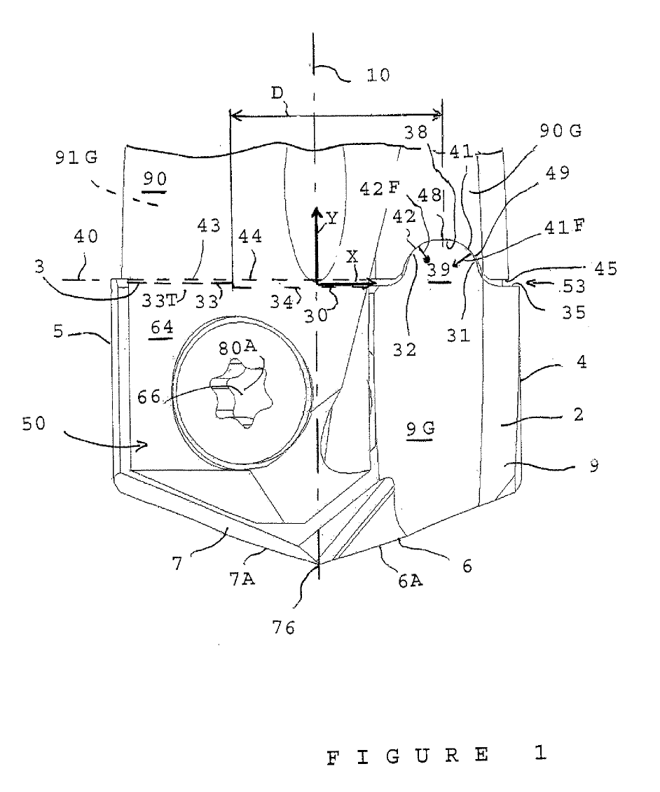

The drill bit shown partially in FIGS. 1, 2 and 3 comprises a shaft 90, with geometric axis of rotation 10, there only being shown an end portion thereof which includes a pocket 50 in the form of a forwardly-open, i.e. in the direction of the bottom of FIG. 1, diametrical slot.

Unless otherwise stated, in this description, references to axial or radial orientation are with reference to axis 10. Similarly, the “forward” direction herein is the functional direction of the drill bit, in other words a direction running from its rear end towards its forward end, that includes pocket 50.

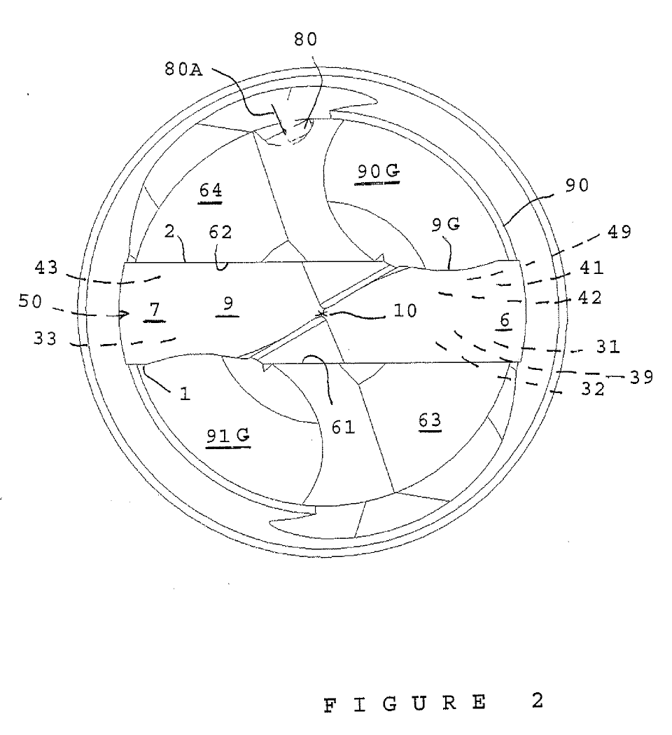

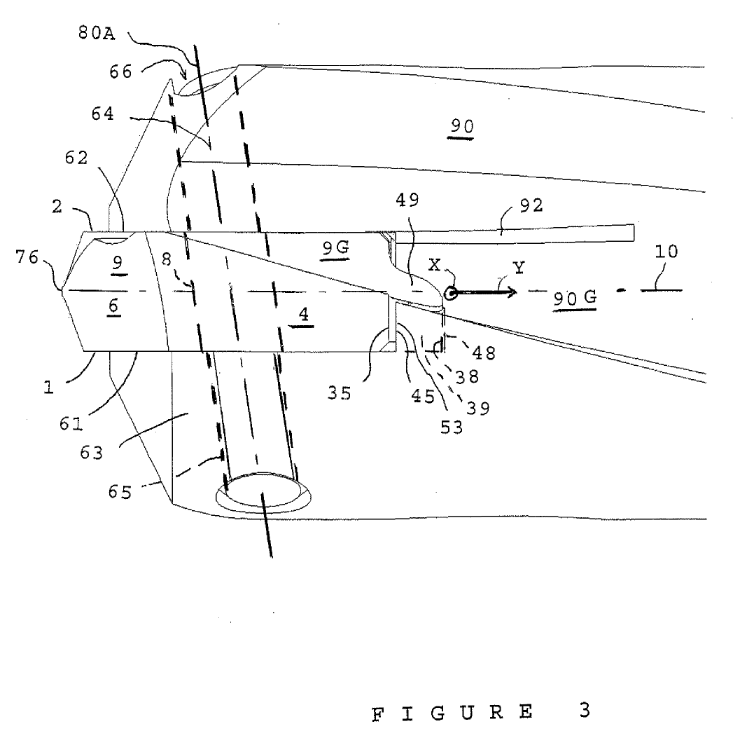

As can be seen better in FIGS. 2 and 3, pocket 50 of FIG. 1 is limited by two major lateral clamping surfaces 61 and 62 which are parallel and here axial, respectively belonging to two slightly flexible cheeks or jaws 63, 64, symmetrically opposed with respect to axis 10. When fitting a cutting insert 9 into shaft 90, the user will typically employ clamping surface 61 as a bearing surface, or base, against which the user will slide insert 9 to bring it to the desired registration position.

In this embodiment, jaw clamping is achieved using a radial screw 18, with geometric axis 80A, the body of which passes freely through a passage 66 in jaw 64, and a central hole 8 in cutting insert 9, for engagement with a threaded hole 65 in cheek 63. Cutting insert 9 is consequently held in the diametrical plane defined by the two clamping surfaces 61 and 62, but its orientation and position in this plane need to be set in advance, this corresponding to two degrees of freedom in translational motion and one degree of freedom in rotation. For practical purposes, we shall call the radial direction in this diametrical plane “X” and the axial direction, rearward directed, “Y”.

To facilitate flexing and bringing together of the two jaws 63, 64, an axial slot 92, nevertheless optional, is provided in registering wall 53 delimiting the rear of pocket 50, this slot extending widthwise between the two lateral walls of the rear registering wall 53, whereby the two jaws 63, 64 are functionally lengthened backwards by a corresponding amount thereby forming two elastically yielding gripping jaws, the anchor point or a point at which they pivot when flexing, being thus axially backward of pocket 50.

Cutting insert 9 has one major supporting face 1 which can bear slidingly against clamping surface 61, opposed to a major supporting face 2, facing clamping surface 62. Abutment faces 1 and 2 each include a substantially axial groove 9G with a rounded transverse profile for chip removal, groove 9G of abutment face 2 extending over a rear registering nose portion member 39, which consequently has a lesser thickness than the thickness of pocket 50. Shaft 90 similarly includes, in the rear extension of the two chip removal grooves 9G, two flutes, respectively 90G, 91G running helically backwards.

FIG. 2 is a front view of the drill bit showing its shaft 90 and a larger diameter base rear portion for mounting into a tool. It will be seen that as a result of opposing flutes 90G, 91G substantially occupying two respective approximately 90° sectors which each “bite into” a lateral edge of clamping surfaces 61 and 62 at each chip removal groove 9G, the solid part remaining of the end portion of shaft 90 occupies two angular sectors, the radial direction of extension of one edge of which is inclined by about 30° with respect to a normal to the clamping surfaces 61, 62. This inclination arises through the fact that screw axis 80A is located in the back part of pocket 50 meaning that the two remaining solid material sectors, at the level of screw axis 80A, have undergone rotation, as a result of the helical shape of the flutes 90G, 91G. Axis 80A of screw 80 is directed in this latter direction so as to be substantially in the center of the remaining material.

For registration purposes, the rear ends of the two clamping surfaces 61, 62 are united by the axially rearward registering wall 53, constituting a rear abutment here extending in a radial plane with an overall direction of extension 40. It will nevertheless be noted that, generally speaking, it is sufficient for registering wall 53 to have two mutually radial spaced portions which are at the least somewhat directed forwardly. Provision could indeed have been made for registering wall 53 to have a lengthwise and/or thickness-wise direction of extension which is inclined on a radial plane. Additionally, it could have been provided for registering wall 53 to be of any desired shape, in other words non-rectilinear and, for example, with a sequence of two mutually oblique segments, as its abutment function is limited to two remote portions.

Registering wall 53 includes a first portion for guiding registration comprising a radial and axial registering relief which here is formed by a relieved undercut portion or recess 49 in the form of a V-shaped notch or groove, i.e. female, with, here, branches which are concave when looking from the inside of the V. Registering recess 49 forms a forwardly-open cradle and, in this example, has symmetrical branches i.e. their mean axis is axial, with thus branches that are generally inclined radially at two angles of the same value and opposite signs, and with a baseline 48, here oriented thickness-wise in a circumferential direction, i.e. perpendicular to the plane in FIG. 1. The distance separating the peaks of the branches of the female V-shape represent the length of the first guiding registering portion. Alternatively, baseline 48 can be oriented obliquely, in other words, in FIG. 1, the baseline can be tilted towards axis 10 and/or forwardly.

The branches of the female V-shape respectively include first and second guiding registering lateral surfaces 41, 42 generally situated at a radial distance D, starting from baseline 48, from a third guiding registering lateral surface 43 which is part of a second portion of the registering wall 53, at a diametrically opposed side. The first guiding registering surface 41, which is the radially outer, is thus partially directed forwardly and partially towards axis 10, in the direction of arrow 41F, while the second guiding registering surface 42, which is also partially turned forwardly, is partially directed away from axis 10, in the direction of arrow 42F, i.e. somewhat towards the first guiding registering surface 41 in this example.

It will be noted that it is sufficient here for the two guiding registering surfaces 41, 42 to be slightly turned one towards the other, meaning that it could be provided, alternatively, for one of the two surfaces to be axial, or even directed backwardly. In the latter case, the upward axial movement involved in bringing cutting insert 9 against guiding registering surface 41 or 42 would, if this surface were partially directed backwardly, be accompanied by a radial movement, for example by sliding over the forwardly directed guide registering surface 41 or 42.

We have called the first, second and third guiding registering surfaces, 41, 42, 43, “guiding surfaces” as it is they which will bring the insert 9 up to its operating position.

An intermediate, non-functional, lateral surface 44 which here is rectilinear and radial, joins the forward end edge of the second, radially inner, guiding registering surface 42 to a radially inner edge of third guiding registering surface 43. Registering wall 53 is limited radially by an optional radially outer lateral surface 45, here radial, bearing in mind that the forward end edge of radially outer guiding registering surface 41, could constitute an end portion of registering wall 53. In this example, third guiding registering surface 43 extends right up to an opposite end.

The major support faces 1 a 2 of insert 9 are linked by a rear positioning lateral registering face 3 adapted to co-operate with registering wall 53, and by two diametrically opposed axial side faces 4 and 5, as well as by two front side faces 6, 7 at axially symmetric positions and including two respective cutting edges 6A, 7A forming a male V, in the plan view of FIG. 1, with the tip thereof on axis 10. The two cutting edges 6A and 7A are respectively delimited by the two major support faces 1 and 2, both being active for a predetermined direction of rotation about axis 10, and linked by a short radial cutting edge of the forward tip 76 of insert 9.

It will be noted that we are dealing with a non-limiting example as the precise form of cutting insert 9 is not relevant to the invention. Thus, the axial side faces 4, 5 could be omitted or could delimit axial or axially inclined cutting edges for conical drilling, and the forward cutting edges 6 and 7 could for example together constitute a cutting nose with a rounded profile. Similarly, when applied to a cutting tool of the milling type forming a wheel with a series of peripheral cutting inserts at the periphery thereof driven in circular translational motion and in which they would consequently not themselves be rotating about a virtual axis passing through them, the cutting edges would be all limited by one common major support face 1 or 2.

Lateral positioning face 3, extending generally in a radial direction of extension 30 has, close to one end, a first portion comprising a registering relief made up by V-shaped male nose portion 39, here rounded, pointing backwardly with a back limiting curve 38 and, once in the registered position, having the same angle of opening and the same orientation as registering recess 49. For the purposes of this description of the relative orientations of the various parts of cutting insert 9, we have supposed that the latter has already become appropriately orientated, in other words that registering face 3 is backward and the direction of extension thereof, 30, is radial.

It can in particular be provided for the inclinations, i.e. angles of tilt in the direction of axis 10, of limiting curve 38 defining the nose portion summit and line 48 at the pocket bottom not to be normal to the plane of the major support surfaces 1 and 2, whereby the reaction force of registering nose portion 39 and its force of contact in registering recess 49 will set up a couple tending to cause insert 9 to pivot about a virtual axis parallel to axis 10 and passing through registering nose portion 39, thereby tending to flatten a radially-opposite region of major support face 1 or 2, close to lateral surface 5, against the associated support surface 61 or 62, the twisting couple thus set up ensuring better stability.

Registering nose portion 39 is radially limited, outwardly and inwardly, by first and second guided registering lateral surfaces 31 and 32 spaced along an extension direction 30 which is both local and general in this example, forming two radially separate branches of a male V-shape with its mean plane axial, the surfaces being directed at least partially in opposing senses with respect to direction of extension 30, the radius of curvature of their convexity being substantially equal to the radius of curvature of the concavity of guiding registering surfaces 41, 42 thereby coupling with them. What is now constituted is a cradle-shaped bearing facilitating eventual slight pivoting of insert 9 upon registration thereof. Registering nose portion 39 thus constitutes an axis for pivoting.

The distance separating the end of curvature of the arms of the male V-shape 31, 32, corresponds to the length of the first guided registering portion. The respective concave and convex shapes of registering recess 49 and registering nose portion 39 are such that there is only abutment at the facing registering surface branches 31, 41 and 32, 42, meaning that a gap is left between line 38 defining the top of the relief and line 48 defining the base of the pocket. Similarly, the forward lateral surfaces of registering recess 49 only constitute a widened mouth portion for facilitating placement of registering nose portion 39, i.e. the two corresponding lateral surfaces, at the base of registering nose portion 39 are at a certain distance from the above mouth portion surfaces once the position of registration is achieved.

Registering face 3 further comprises a second registering portion constituted by a third lateral registering surface 33 generally situated at a distance D from registering nose portion 39, in a radial direction in this example. The third registering surface 33 which should be directed at least partially forwardly to act as a rear abutment, is here of purely radial extension (30), in other words totally directed forwards. It could nevertheless be provided for the third registering surface 33 to extend obliquely with respect to radial direction 30, i.e. functionally replacing one of the first and second lateral registering surfaces 31, 32, this surface then acting solely as a front abutment, in other words providing locally a clearance distance with respect to registering wall 53. Under these conditions, the choice of the precise relative position, on lateral registering surface 3 and/or the increased axial size, resulting from the heel portion, of third registering surface 33, now oblique, makes it possible to determine also a local clearance distance opposite thereto.

An intermediate lateral surface 34, which here is rectilinear and radial, having no functional purpose, connects the radial inner edge of registering nose portion 39 to a facing radial inner edge of third registering surface 33. Registering face 3 is here bounded by an end lateral surface 35, which here is rectilinear and radial, of small radial extension, in other words the distance “D” is preferably chosen to be relatively large with respect to the width of cutting insert 9, typically at least 50%, even 70% or possibly even 80%, to ensure good rear seating counteracting tilting. Further, the possible presence of debris on one of registering surfaces 31-33 or 41-43 will not have the effect of axially amplifying, at the radial extremity 35 of registering face 3, an error in axial positioning which the above registering abutment areas might exhibit.

We can consider the first, second and third registering surfaces 31, 32, 33 as being “guided” since they will be guided by the surfaces 41, 42, 43 for “guiding” registering up to their desired operating position.

In operation, cutting insert 9 is forced up against registering wall 53 by a reaction force transmitted by cutting edges 6A, 7A and 76 bearing on a workpiece, meaning that insert 9 acts like a transverse beam member supported at one end by registering nose portion 39 against first and second guiding registering surfaces 41, 42 of recess 49, and opposite thereto in the radial sense, by third guided surface 33 bearing against the third guiding registering surface 43.

To ensure axial clearance between the surfaces of each pair of facing nonfunctional surfaces 34, 44 and 35, 45, one of either the third guided registering surface 33 or the third guiding registering surface 43 slightly projects axially with respect to the remainder of the relevant registering face or guiding registering wall, 3 or 53, in other words is offset forwardly or backwardly, with respect to its general direction of radial extension 30 or 40, in the direction of the other, Here, it is the third guided registering surface 33 which is offset backwardly through a plateau-like extension forming a registering heel portion 33T of which the rear surface forms the third guided surface. Symmetrically, registering nose portion 39 is slightly longer than the axial depth of registering recess 49, to ensure at least a minimum axial clearance.

As discussed earlier, cutting insert 9 can be readily positioned by pushing it in the backward sense so as to cause registering nose portion 39 to enter somewhat into registering recess 49. Registering nose portion 39 now constitutes, in radial direction X, a radial centering pin so that third guided registering surface 33 comes up against third guiding registering surface 43 and occupies, at the opposite end, exactly the desired radial position when the first and second guided registering surfaces of registering nose portion 39 are respectively in contact with the first and second guiding registering surfaces 41, 42, and against which they bear.

In particular, one useful manner of operation consists in forcing the registering nose portion 39 as far as possible into registering recess 49 even if cutting insert 9 is still not perfectly oriented (axially), after which insert 9 is pushed backwardly for instance at its forward pointed region 76 so that it is caused to pivot about registering nose portion 39 up until the third registering surfaces 33 and 43 come into contact. During this rotation, the orientation of registering nose portion 39 will approach the desired axial orientation so that registering nose portion 39 terminates its penetration movement as far as the bottom 48 of registering recess 49.

In this example, contact between registering nose portion 39 and registering recess 49 is established over a certain length of each branch of the female or male V-shape, with the exception of the region situated at the base of the registering nose portion which guarantees clearance. Alternatively, contact at first and second registering surfaces 31, 41 and 32, 42 can be designed for a more punctual contact, for example along two respective lines generating a surface which are substantially parallel to the baseline of registering recess 48, in other words perpendicular to the major supporting faces 1 and 2. It will be also noted that it is not necessary for registering recess 49, as in this example, to be a groove extending over a distance corresponding to the thickness of insert 9. In other words, it is not essential for registering nose portion 39 to occupy the whole thickness of cutting insert 9.

Generally speaking, the first, second and third registering surfaces 31, 32, 33 have a total registering surface which only makes up a small proportion of the surface of registering surface 3 of which they constitute a part. Preferably, this proportion is less than 20%, more preferably less than 10% and even more preferably less than 5%. When measuring each lateral guided registering surface 31-33, in other words that surface region which is functional, we can suppose that the corresponding registering guiding wall 41-43 does have registering reliefs with surfaces with shapes and relative positions that exactly match those of the guided lateral registering surfaces 31-33.

Additionally, as two of the lateral registering surfaces 31, 32 are grouped together, the first registering portion that includes them preferably makes up less than 20% of the total length of lateral surface 3 (or alternative embodiments thereof), and more preferably less than 10%. Intermediate lateral surface 34 linking the radial inner edge of second registering lateral surface 32 (or alternative embodiments thereof) with its facing radially inner edge of third registering surface 33 is of a length (slightly less than overall distance D) preferably making up at least 50%, more preferably at least 70% of the total length of lateral surface 3 of which they are a part, even more preferably at least 80%. It is thus this length which mutually separates the first and second guided registering portions.

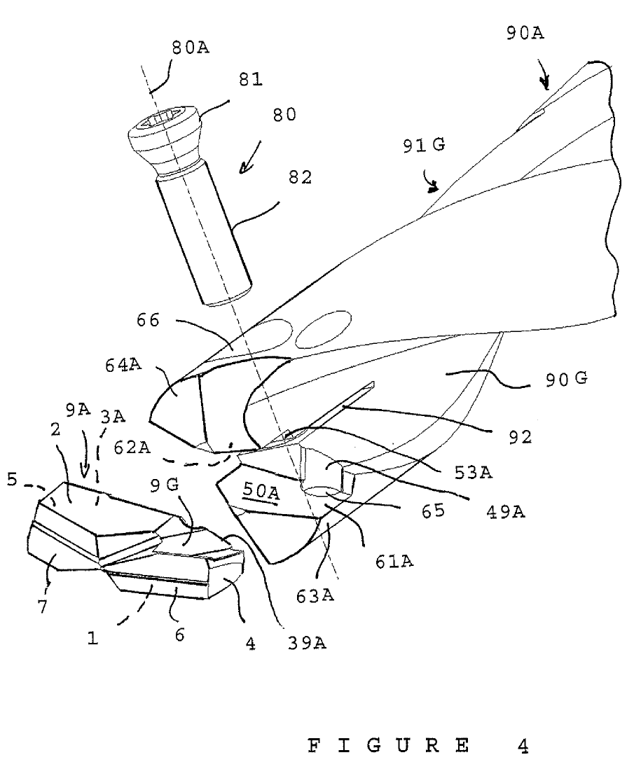

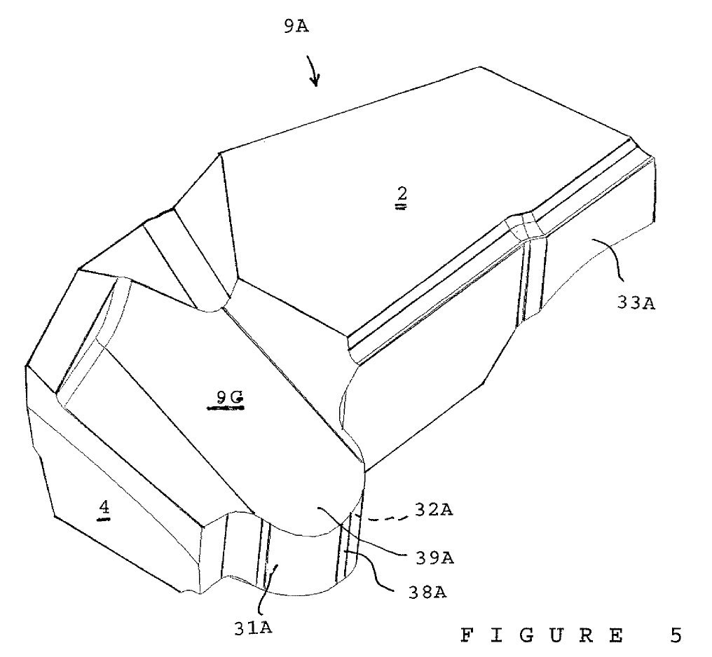

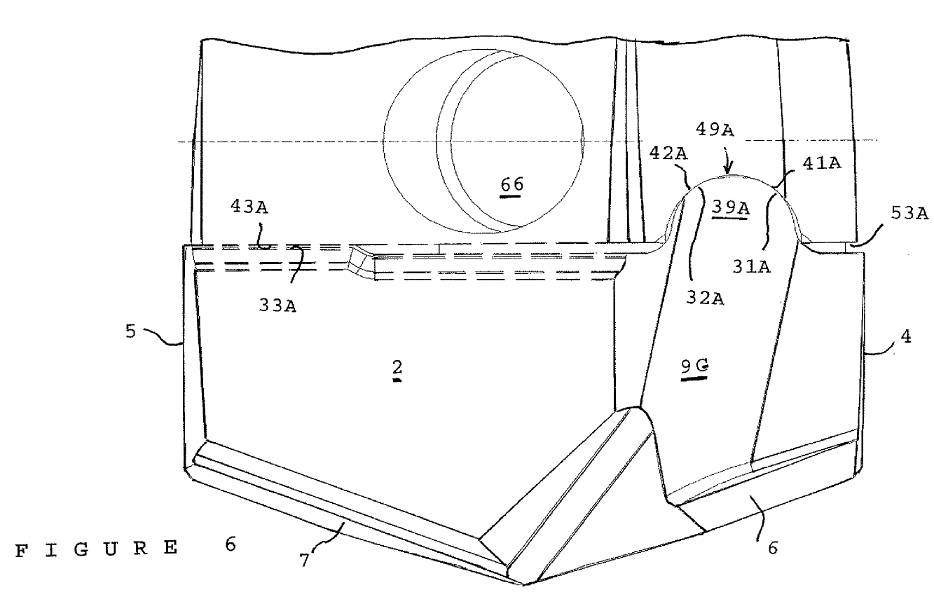

The cutting insert of FIGS. 4, 5, 6 and 7 is an alternative embodiments which differs from that of FIGS. 1 to 3 by the fact that the securing screw 80 with head 81 and body 82 only passes through shaft 90A, behind cutting insert 9A, with the result that the latter insert is shorter than cutting insert 9.

Those functional parts which are unchanged here carry the same reference numerals as those in FIGS. 1 to 3 and those the shape of which has been modified carry the same reference numeral as originally, followed by the suffix A. The various functions remain unchanged and for the sake of conciseness, we shall not repeat the explanations regarding general shape, function and operation of the various parts. We shall here only discuss differences with respect to FIGS. 1 to 3.

The central hole 8 in insert 9 is here omitted with the result that cutting insert 9A is now axially shorter than cutting insert 9. In effect, as insert 9 or 9A forms a beam supported at the back at two extremities of its lateral positioning face 3 or 3A and gets pushed backwards by its tip i.e. at the midpoint of the beam, a central hole 8 would constitute a region of weakness, requiring a relatively long (in the axial sense) insert 9.

To avoid having to provide a central hole 8 in insert 9, rear end axial slot 92 is here necessary. The jaw portions 63A, 64A now form two levers one opposite to the other of which it suffices to bring their two respective base portions together to bring the two free end portions defining pocket 50A together, thereby clamping cutting insert 9A.

Nose portion 39A defined by the line 38A has a rounded top profile, with first and second guided lateral registering surfaces 31A and 32A, for co-operation with the first and second lateral guiding registering surfaces 41A, 42A of the mounting cradle or recess 49A in the form of an open-armed U-shaped recess or groove. The third lateral registering surface 33A co-operates with the third lateral guiding registering surface 43A provided in registering wall 53A.

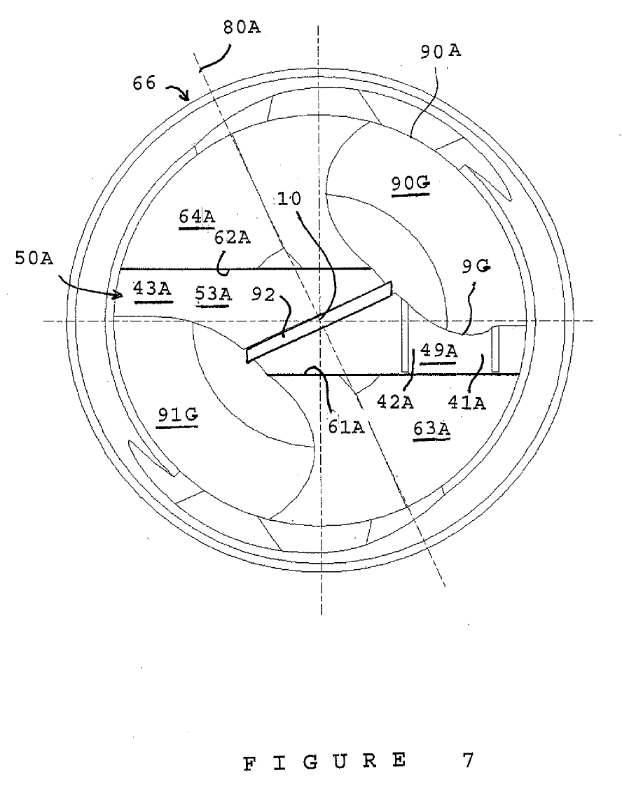

FIG. 7 is a front view of the drill bit with its shaft 90A showing the pocket 50A and the rear axial slot 92, together with two flutes 90G, 91G.

1. A cutting insert comprising a registered positioning lateral face of registration against a lateral registering wall of a pocket in a tool holder, wherein the registered positioning lateral face comprises:
a first registering portion comprising a guided registering relief for constraining two degrees of freedom of motion of the cutting insert on a base of said pocket, the guided registering relief comprising first and second guided registering lateral surfaces provided for registration abutment against respective first and second guiding registering lateral surfaces belonging to a guiding relief of said tool holder pocket; and
at a determined distance from the first registering portion, a second registering portion comprising a third guided registering lateral surface for constraining a further degree of freedom of motion of said cutting insert on said base of the pocket, through abutment against a third guiding registering lateral wall surface of said tool holder pocket,
wherein the first and second guided registering surfaces are mutually inclined so as to ensure registration in a determined traveling position with respect to the guiding registering lateral surfaces opposite thereto, the guided relief constituting, once in engagement with the guiding relief, an axis for a final rotational movement by means of which the third guided lateral surface is pushed back against the third guiding lateral wall surface.

2. The cutting insert of claim 1, wherein the first and second guided registering lateral surfaces are directed at least partially in opposite senses with respect to a local direction of extension of the registered positioning lateral face.

3. The cutting insert of claim 1, wherein the first and second guided registering lateral surfaces extend in mutually inclined general directions of extension.

4. The cutting insert of claim 1, wherein the first and second guided registering lateral surfaces are convex.

5. The cutting insert of claim 1, wherein said guided registering relief is a registering nose portion.

6. The cutting insert of claim 1, wherein the third guided registering lateral surface is carried by a registering heel.

7. The cutting insert of claim 1, wherein the guided registering relief is constituted by two separated local reliefs respectively carrying the first and second guided registering lateral surfaces.

8. The cutting insert of claim 1, wherein the total registering surface of the first, second and third guided registering lateral surfaces is less than 20% of the surface of the registered positioning lateral face.

9. The cutting insert of claim 1, wherein said first registering portion makes up less than 20% of the total length of the registered positioning lateral face.

10. The cutting insert of claim 1, wherein the first and second registering portions are separated by a distance which preferably corresponds to at least 50% of the value for the total length of the lateral surface that includes them.

11. The cutting insert of claim 1, having no central hole adapted for the passage of a screw.

12. The cutting insert of claim 1, adapted to be clamped in said pocket by two jaws bounding the pocket.

13. A tool holder adapted to receive a cutting insert comprising an insert pocket having a registering lateral wall comprising:
a first registering wall portion comprising a guiding registering relief for constraining two degrees of freedom of motion of the cutting insert at a base of the pocket, said guiding registering relief having first and second guiding registering surfaces adapted to receive respectively, in registration abutment therewith first and second guided registering lateral surfaces of a guided relief of the cutting insert; and
at a determined distance from said first registering wall portion, a second guiding registering wall portion comprising a third guiding lateral surface for constraining a further degree of freedom of motion of the cutting insert on the base of said pocket, by receiving in abutment therewith a third guided surface of lateral registering wall of the cutting insert,
wherein the first and second guiding registering surfaces are mutually inclined so as to provide to the guided registering lateral surfaces of the cutting insert, opposite to the guiding registering surfaces, registration in a determined traveling position, said guiding relief being adapted so that the guided relief constitutes, once in engagement with the guiding relief, an axis for a final rotational movement by means of which the third guided lateral surface is pushed back against the third guiding lateral wall surface.

14. The tool holder of claim 13, wherein the first and second guiding registering lateral surfaces are at least partially directed in opposite senses with respect to a direction of local extension of the lateral registering wall.

15. The tool holder of claim 13, wherein the general directions of extension of the first and second guiding registering lateral surfaces are mutually inclined.

16. The tool holder of claim 13, wherein said guiding registering relief is a recess, the first and second guiding registering lateral surfaces being concave.

17. The tool holder of claim 13, wherein the pocket is bounded by two jaws adapted to clamp the cutting insert, a wall limiting the rear of said pocket having an axial slot to facilitate flexing of the two jaws towards each other.

18. The tool holder of claim 17, wherein the pocket is formed in a shaft of the tool holder, the tool holder being adapted to receive a clamping screw which only passes through said shaft, behind the cutting insert.

19. A set comprising a tool holder and a cutting insert adapted to be mounted on the tool holder, wherein the cutting insert comprises a registered positioning lateral face of registration against a lateral registering wall of a pocket in the tool holder, wherein the registered positioning lateral face comprises:
a first registering portion comprising a guided registering relief for constraining two degrees of freedom of motion of the cutting insert on a base of said pocket, the guided registering relief comprising first and second guided registering lateral surfaces provided for registration abutment against respective first and second guiding registering lateral surfaces belonging to a guiding relief of said tool holder pocket; and
at a determined distance from the first registering portion, a second registering portion comprising a third guided registering lateral surface for constraining a further degree of freedom of motion of said insert on said base of the pocket, through abutment against a third guiding registering lateral wall surface of said tool holder pocket,
wherein the first and second guided registering surfaces are mutually inclined and the first and second guiding registering surface are mutually inclined so as to ensure registration in a determined traveling position, with respect to the guiding registering lateral surfaces opposite thereto, the guided relief constituting, once in engagement with the guiding relief, an axis for a final rotational movement by means of which the third guided lateral surface is pushed back against the third guiding lateral wall surface.
